(19) United States
(12) Patent Application Publication
(10) Pub. No.: US 2026/0146491 A1
(43) Pub. Date: May 28, 2026

(54) CABINET WITH SLIDING DOORS

(71) Applicant: Synergy House Furniture Sdn Bhd, Shah Alam (MY)

(72) Inventor: Eu Tah TAN, Shah Alam (MY)

(21) Appl. No.: 19/084,829

(22) Filed: Mar. 20, 2025

(30) Foreign Application Priority Data
Nov. 22, 2024 (MY) PI2024006684

(51) Int. Cl. E06B 3/46; A47B 47/04; E05D 15/06

(52) U.S. Cl. CPC E06B 3/46; A47B 47/045; E05D 15/06; E05Y 2900/20

(57) ABSTRACT

The invention discloses a cabinet comprises a top panel (100), a base panel (200), a plurality of vertical posts (500) supporting the top panel (100) above the base panel (200), creating a storage space therebetween, and one or more slat doors (300) vertically fitted in guide grooves (400) formed on the top panel (100) and the base panel (200), wherein the slat doors (300) are slidable between an open position where at least a front of the storage space is exposed and a closed position where at least the front of the storage space is concealed.

### TECHNICAL FIELD

The invention relates to a cabinet, and more particularly, to a cabinet with slat doors that are slidable between open and closed positions.

### BACKGROUND

Cabinets are widely utilized in residential, commercial, and industrial environments to provide organized and efficient storage solutions. Conventional cabinet designs predominantly feature hinged doors that swing outward from the cabinet body. While these doors are simple in construction and reliable in operation, they require a substantial clearance space in front of the cabinet to function properly. Such requirement poses challenges in confined environments, such as small rooms, corridors, or spaces with restricted accessibility, where every inch of usable area is crucial. As a result, hinged-door cabinets are often unsuitable for modern, space-conscious applications.

To address these constraints, sliding door mechanisms have been developed. Sliding doors operate along linear tracks integrated into the cabinet structure, enabling the doors to move laterally without encroaching on the space in front of the cabinet. This design eliminates the need for outward clearance and is particularly suitable for use in tight spaces. However, sliding door systems introduce their own limitations. To accommodate the sliding tracks, the cabinet must often be widened, consuming additional lateral space and reducing its practicality in compact storage applications. Furthermore, the reliance on straight tracks constrains the flexibility of the cabinet's design, limiting its adaptability and aesthetic appeal in customized or modern layouts.

Another alternative is the incorporation of shutter doors, which are composed of multiple interconnected slats forming a flexible, rollable panel. These doors operate along tracks that can adopt various configurations, including spiral tracks within the cabinet. A relevant example is disclosed in European Patent No. EP1875025B1, which describes a cabinet unit featuring at least one door element, such as a louvered, tambour, or sliding door. The disclosed design includes a running track secured to the cabinet, a deflection track operatively connected to the running track, and a cover element that extends beyond at least one free end of the running track. The cover element is partially connected to both the deflection and running tracks. The running track further features an approximately U-shaped recess with two edge-side webs, and its free end is equipped with an end piece of a similar U-shaped configuration.

While the spiral track system of shutter doors effectively eliminates the need for external clearance space and avoids the additional width required by linear sliding tracks, it presents another drawback. The spiral track mechanism occupies a significant portion of the cabinet's internal volume, reducing the available storage space. This trade-off limits its practicality for users who prioritize maximizing the internal capacity of the cabinet.

Therefore, there is a need for an improved cabinet design that can overcome the limitations identified above. This invention provides such a cabinet.

### SUMMARY

According to one embodiment of the invention, there is provided a cabinet comprises a top panel, a base panel, a plurality of vertical posts supporting the top panel above the base panel, creating a storage space therebetween, and one or more slat doors vertically fitted in guide grooves formed on the top panel and the base panel, wherein the slat doors are slidable between an open position where at least a front of the storage space is exposed and a closed position where at least the front of the storage space is concealed.

According to this embodiment, each vertical post may comprise an elongate cylindrical body having a top end with a first fastening profile for attachment to the top panel, and a bottom end with a second fastening profile for attachment to the base panel.

According to this embodiment, the elongate cylindrical body may be constructed from multiple members joined in an end-to-end configuration to form its full intended length.

According to this embodiment, the first fastening profile may include an internal threaded surface engageable with a receiving member fitted in a hole on the top panel.

According to this embodiment, the receiving member may comprise an outer wall with a plurality of external teeth for firm engagement with an inner surface of the hole on the top panel, and a flange, with an external threaded surface, located within the outer wall for engagement with the internal threaded surface of the first fastening profile.

According to this embodiment, the second fastening profile may include an external threaded surface engageable with an internal threaded surface of a leg member in such a way that the base panel is clamped between the base end of the vertical post and the leg member.

According to this embodiment, the leg member may comprise a main body, and a flange extending upwardly from the main body into a through hole on the base panel, whereby the flange being recessed at a depth into a centre of the main body to form an edge that clamps the base panel against the bottom end of the vertical post.

According to this embodiment, the cabinet may further comprise an intermediate panel for dividing the storage space into an upper space and a lower space,

According to this embodiment, the intermediate panel may be supported horizontally between the top panel and the base panel by one or more first vertical posts disposed within the upper space and one or more second vertical posts disposed within the lower space.

According to this embodiment, the second fastening profile of the first vertical posts may be engageable with the first fastening profile of the second vertical posts in such a way that the intermediate panel is clamped between the vertical posts.

According to this embodiment, the elongate cylindrical body may include one or more slots extending along a length of the body, each slot is configured to receive an edge of a partitioning panel in such a way that the partitioning panel can be slidably inserted between two adjacent vertical posts positioned side by side on a same horizontal plane.

According to this embodiment, the vertical posts may be made of plastic or metal.

According to this embodiment, each slat door may comprise a plurality of vertical slats attached to a fabric sheet by an adhesive.

According to this embodiment, the guide grooves may comprise curved portions at corners of the top and base panels, allowing the slat doors to adopt a curved configuration at the corners.

According to this embodiment, the guide grooves may comprise openings at the sides of the top and bottom panels, configured to allow the slat doors to be slidably inserted into the guide grooves.

According to this embodiment, the cabinet may further comprise side panels for enhancing the structural support of the top panel above the base panel and blocking the openings in the guide grooves to prevent the slat doors from exiting.

According to this embodiment, an exposing surface of the side panels may be attached with a plurality of slats or a decorative layer configured to mimic the appearance of the slat doors.

According to a further embodiment of the invention, there is a cabinet comprises a top panel, a base panel, a plurality of vertical posts supporting the top panel above the base panel, creating a storage space therebetween, and two pair of slat doors vertically fitted in guide grooves formed on the top panel and the base panel.

According to this embodiment, a first pair of the slat doors may be slidable between an open position, in which at least a front of the storage space is exposed, and a closed position, in which at least the front of the storage space is concealed.

According to this embodiment, a second pair of the slat doors may be slidable between an open position, in which at least a back of the storage space is exposed, and a closed position, in which at least the back of the storage space is concealed.

According to this embodiment, both pairs of the slat doors may conceal the sides of the storage space in both the open position and the closed position.

According to this embodiment, the slat doors may divide the storage space into a front storage space and a back storage space when in the open position.

One skilled in the art will readily appreciate that the invention is well adapted to carry out the objects and obtain the ends and advantages mentioned, as well as those inherent therein. The embodiments described herein are not intended as limitations on the scope of the invention.

### BRIEF DESCRIPTION OF THE DRAWINGS

For the purpose of facilitating an understanding of the invention, there is illustrated in the accompanying drawing the preferred embodiments from an inspection of which when considered in connection with the following description, the invention, its construction and operation and many of its advantages would be readily understood and appreciated.

FIG. 1 illustrates an embodiment of a cabinet having slidable slat doors in a closed position.

FIG. 2 illustrates the cabinet with its slidable slat doors in an open position.

FIG. 3 is an exploded view of the cabinet.

FIG. 4 is a cross-sectional view of the cabinet with its slidable slat doors in the closed position.

FIG. 5 is a cross-sectional view of the cabinet with its slidable slat doors in the closed position.

FIG. 6 is an enlarged view taken from section A of FIG. 3.

FIGS. 7a-7c illustrates a first embodiment of a vertical post of the cabinet.

FIGS. 8a-8b illustrates an operation of the vertical post.

FIGS. 9a-9c illustrates a second embodiment of the vertical post.

FIGS. 10a-10b illustrates the operation of the vertical post.

### DETAILED DESCRIPTION

Hereinafter, the invention shall be described according to the preferred embodiments of the present invention and by referring to the accompanying description and drawings. However, it is to be understood that limiting the description to the preferred embodiments of the invention is merely to facilitate discussion of the present invention and it is envisioned that those skilled in the art may devise various modifications without departing from the scope of the appended claim.

As used herein, the terms “top panel” and “base panel” are not intended to be limited to the uppermost and bottommost panels of the cabinet, respectively. These terms are used for the convenience to describe relative positions in the cabinet structure but may also include panels arranged in side-by-side configurations where the cabinet is oriented horizontally. Additionally, in a stacked arrangement of multiple cabinets, a “top panel” or “base panel” may serve as an intermediate panel shared between adjacent stacked units. Furthermore, the term “vertical post” is not restricted to members oriented strictly upright but may include structural posts arranged at any angle, provided they perform a supporting or partitioning function within the cabinet. Similarly, the terms “front”, “back”, and “sides” should not be construed narrowly. The “front” may refer to any direction relative to the component's overall orientation or use, and the “back” or “sides” may refer to an opposite or alternative side. These terms are intended to provide general reference points without imposing specific spatial limitations.

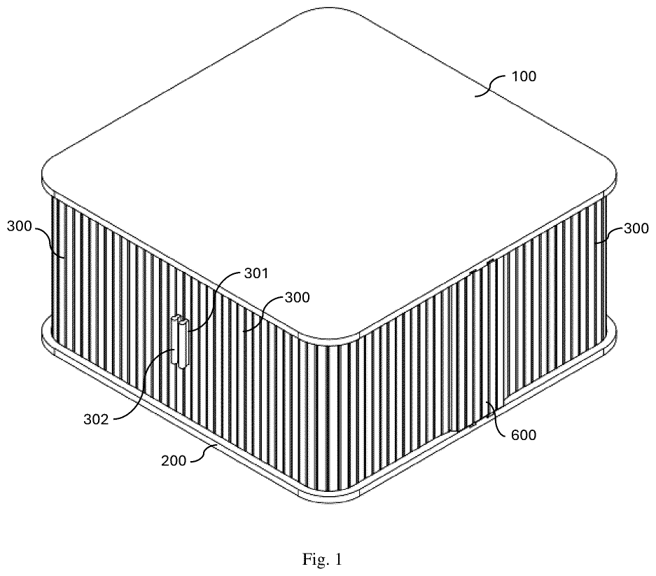

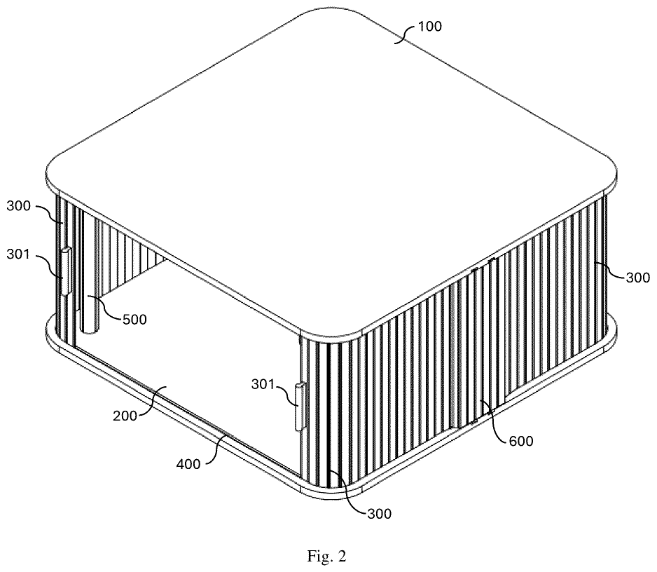

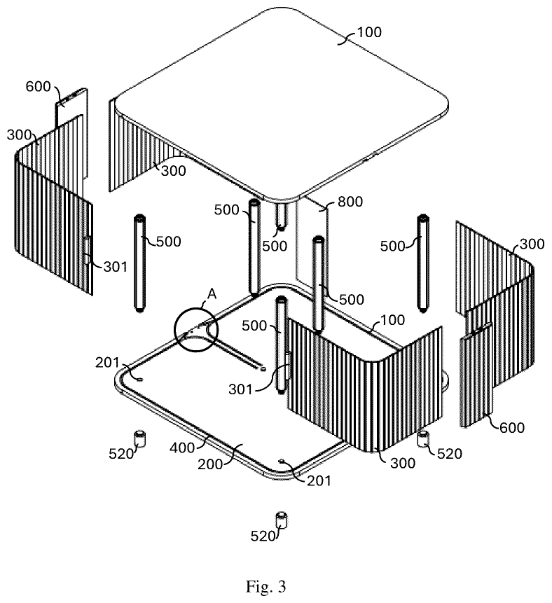

Referring to FIGS. 1 to 5, an embodiment of a cabinet as illustrated therein generally comprises a top panel 100 and a base panel 200, which are horizontally supported by a plurality of vertical posts 500 in a space apart manner to create a storage space between the panels 100, 200. The base panel 200 includes one or more guide grooves 400 and in vertical alignment therewith is a similar guide groove 400 (not shown) in the top panel. The guide grooves 400 generally extend in proximity to the front edge, the side edges, and partially to the back edge of the panels 100, 200, forming C-shaped path.

More specifically, a pair of guide grooves 400 are provided on each panel 100, 200. A first guide groove 400 extends in proximity to the front edge, the side edges and toward a centre of the panels 100, 200, while a second guide groove 400 extends in proximity to the back edge, the side edges and a centre of the panels 100, 200. The pair of guide grooves 400 are configured to avoid intersecting or intervening with each other.

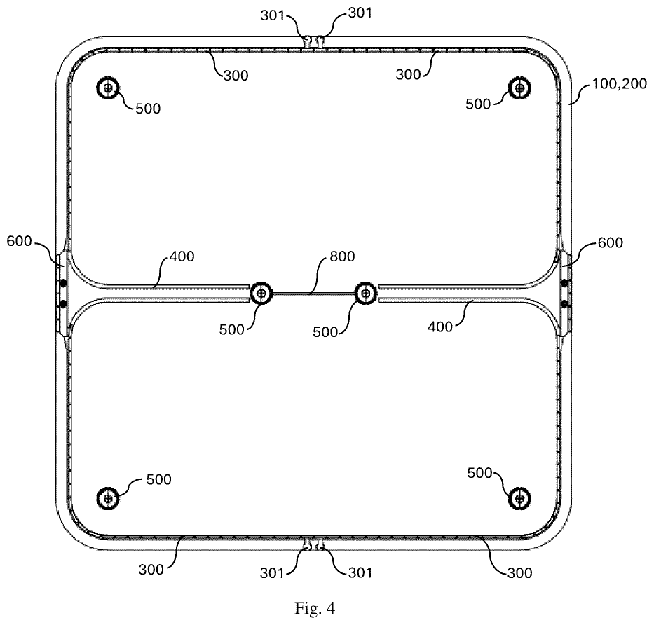

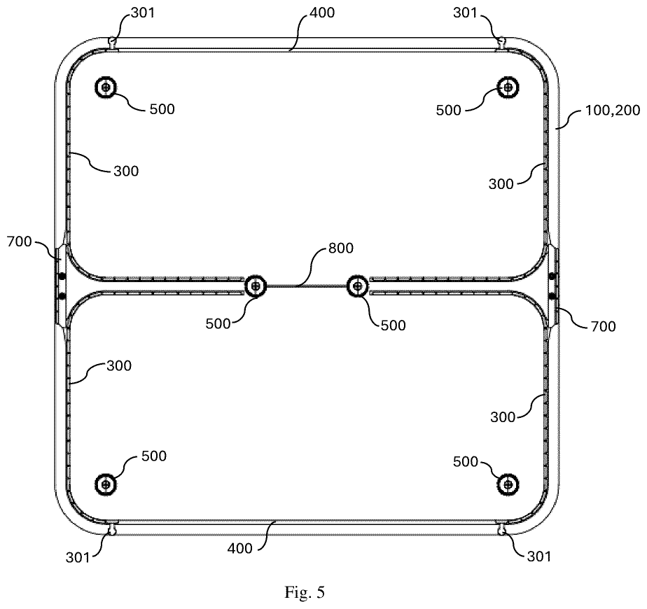

Preferably, one or more slat doors 300 are vertically fitted into the guide grooves 400. The slat doors 300 are slidable between an open position, where at least the front of the storage space is exposed, and a closed position, where the storage space is concealed. In the specific embodiment of the invention, a first pair of slat doors 300 is fitted to the first guide groove 400 while a second pair of slat doors 300 is fitted to the second guide groove 400. The sliding doors 300 are preferably of such length that when in the closed position as shown in FIG. 4, the first pair of slat doors 300 conceals the front and the sides of the storage space, while the second pair of slat doors 300 conceals the back and the sides of the storage space. When wholly closed, the cabinet presents a neat, compact, attractive appearance. In the open position as shown in FIG. 5, the front and/or the back of the storage space is exposed, while both pairs of slat doors 300 continue to conceal the sides and partially the centre of the storage space. A door handle 301 can be attached to the slat doors 300 to assist with their sliding movements. Alternatively, a door latch mechanism can be provided to hold the slat doors 300 in the closed position. Preferably, each slat door 300 is constructed from a plurality of vertical slats attached to a flexible backing material, such as a fabric sheet, using adhesive. This construction enables the slat doors 300 to bend and conform to the curvature of the guide grooves 400. Each vertical slat may feature a flat side and a rounded side. The rounded side can be laminated with a decorative layer to provide an intended aesthetic appeal. The vertical slats can be made of composite wood or plastic. The guide grooves 400 are configured with curved portions near the corners of the top and base panels, permitting the slat doors 300 to adopt a curved configuration and slide smoothly around the corners.

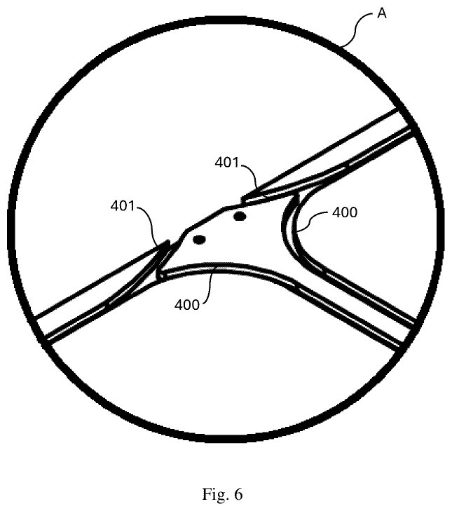

As shown in FIG. 6, each guide groove 400 may be provided with an opening 401 at the sides of the cabinet to facilitate the insertion of the slat doors 300. To prevent the slat doors 300 from exiting the guide grooves 400 during operation, side panels 600 are attached to the cabinet to cover the openings 401. Additionally, an exposing surface of the side panels 600 can be attached with slats or a decorative layer to mimic the appearance of the slat doors 300, thereby creating a visually cohesive and harmonious design between the side panels 600 and the slat doors 300.

In one alternative embodiment, the light-emitting diodes can be strategically positioned inside the cabinet to illuminate the interior. The light-emitting diodes is operatively connected to a sensor mechanism, such as a proximity or motion sensor, configured to detect the position or movement of the slat doors 300. By way of example, when the slat doors 300 slide into the open position, the sensor mechanism may activate the light-emitting diodes, providing sufficient lighting to the exposed storage area. Conversely, when the slat doors 300 return to the closed position, the sensor mechanism may switch off the light-emitting diodes. The sensor mechanism may be integrated into the guide grooves 400 or mounted adjacent to the slat doors 300.

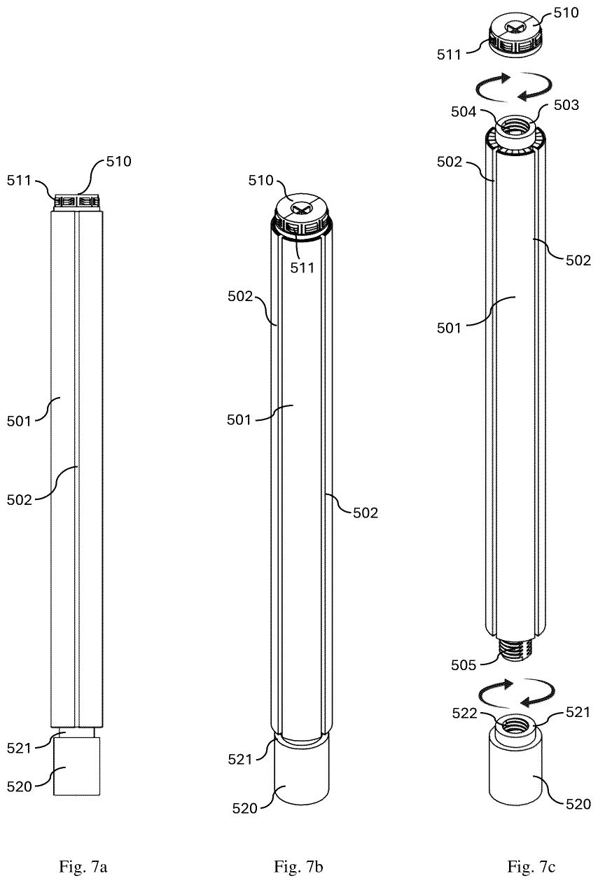

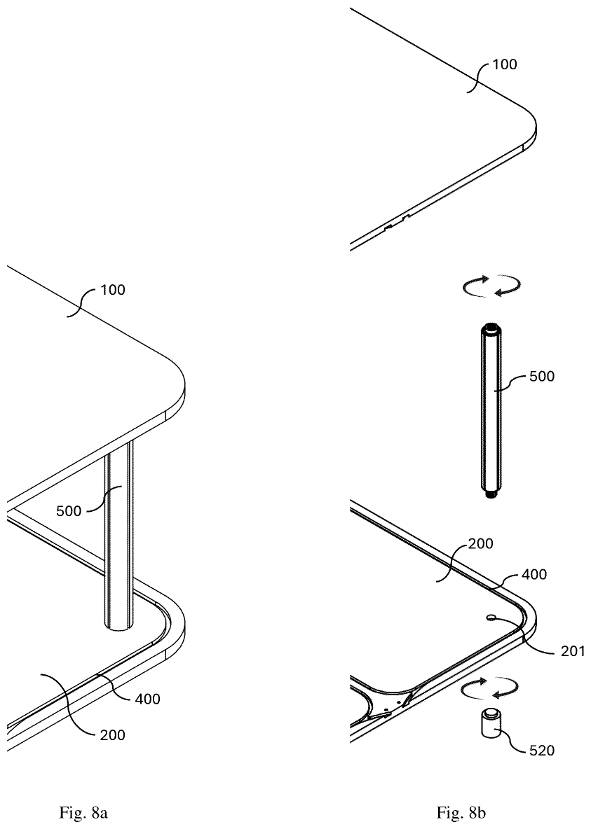

Referring to FIGS. 7a to 8b, a first embodiment of the vertical post 500 is illustrated. Preferably, each vertical post 500 comprises an elongate cylindrical body 501 with a top end and a bottom end. The top end includes a first fastening profile, which features a flange 503 having an internal threaded surface 504 engageable with a receiving member 510 fitted into a hole on the top panel 100. The flange 503 is recessed at a depth into a centre of the cylindrical body 501. The receiving member 510 may comprise an outer wall with a plurality of external teeth 511 for firm engagement with an inner surface of the hole on the top panel 100, and a flange (not shown) located within the outer wall, having an external threaded surface for engagement with the internal threaded surface 504 of the first fastening profile.

The connection between the top end of the cylindrical body 501 and the top panel 100 can be achieved in one of the two ways. In the first method, the receiving member 510 is inserted into the hole of the top panel 100, and then the first fastening profile is attached to the receiving member 510 via screw engagement. In the second method, the receiving member 510 is firstly screwed onto the top end of the cylindrical body 501, after which the top panel 100 is press-fitted onto the vertical posts 500 by aligning the hole with the receiving members 510 on the vertical posts 500.

Preferably, the bottom end includes a second fastening profile, which features an external threaded surface 505 engageable with an internal threaded surface 522 of a leg member 520 in such a way that the base panel 200 is clamped between the vertical post 500 and the leg member 520. In one example, the second fastening profile includes a projection with the external threaded surface 505. The leg member 520 may comprise a main body with a flange 521 extending upwardly from the main body into a through hole 201 on the base panel 200. The flange 521 is recessed at a depth into a centre of the main body to form an edge that clamps the base panel 200 against the bottom end of the vertical post 500. The flange 521 may also include the internal threaded surface 522. The arrangement of the flange 521 is similar to or same as the first fastening profile at the top end of the vertical post 500. Alternatively, the elongate cylindrical body 501 of the vertical posts 500 may be constructed from multiple members joined in an end-to-end configuration to form its full intended length.

Preferably, the cylindrical body 501 further includes one or more slots 502 extending longitudinally along its length. The slots 502 are configured to accommodate edges of partitioning panels 800 in such a way that the partitioning panels 800 can be each slidably inserted between two adjacent vertical posts 500 positioned side by side on a same horizontal plane. Referring back to FIG. 4, a partitioning panel 800 is shown inserted between two adjacent vertical posts 500 located at the centre of the storage space. In combination with the slat doors 300 in their open position, the partitioning panel 800 effectively divides the storage space into a front storage space and a rear storage space. It should be noted that additional partitioning panels 800 can be included to further divide the storage space and to enhance the structure integrity of the cabinet.

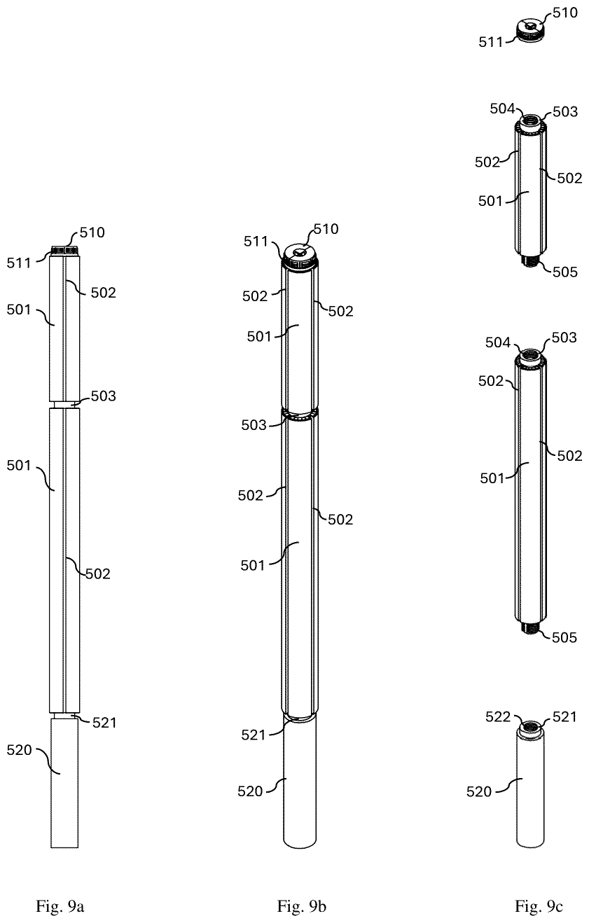

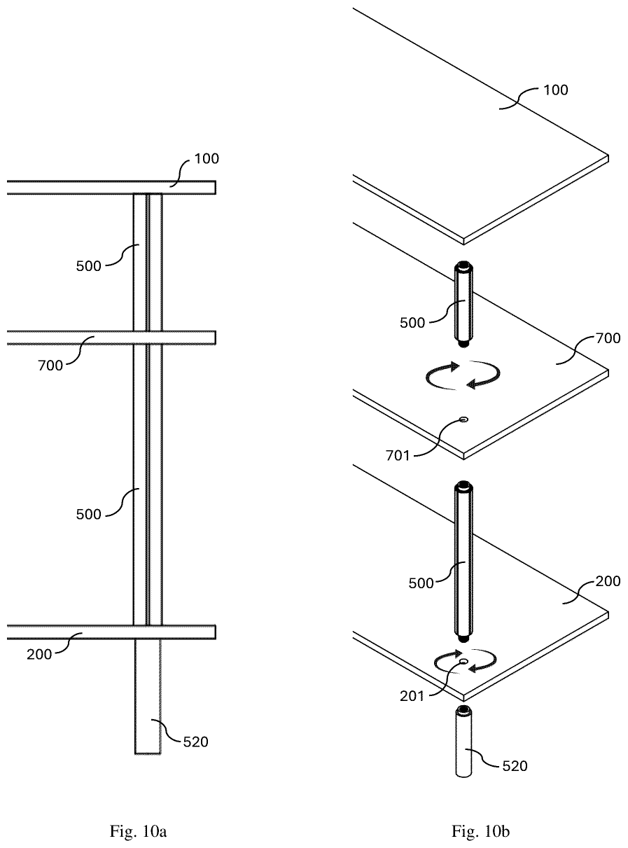

Referring to FIGS. 9a to 10b, the cabinet may further comprise an intermediate panel 700 positioned horizontally between the top and base panels 100, 200 to subdivide the storage space into an upper space and a lower space. The intermediate panel 700 is supported by one or more first vertical posts 500 located in the upper space and one or more second vertical posts 500 in the lower space. In this embodiment, the first and second vertical posts 500 respectively include the elongate cylindrical body 501 with a top end having the first fastening profile and the bottom end having the second fastening profile. The first and second fastening profiles are connectable in such a way that the intermediate panel 700 is clamped between the first and second vertical posts 500.

The vertical posts 500 are preferably constructed from materials such as plastic or lightweight metals to ensure sufficient structural integrity while minimizing the overall weight of the cabinet. Furthermore, the vertical posts 500 are easier to assemble and maximize the use of storage space within the cabinet, providing greater capacity compared to storage areas formed by panels. In one specific embodiment, the cylindrical body 501 is a single-piece structure manufactured through a plastic injection molding process. Suitable plastic materials for this process include acrylonitrile butadiene styrene, polypropylene, polycarbonate, nylon, or combinations thereof. The top panel 100, base panel 200, intermediate panel 700, and the partitioning panel 800 may be fabricated from wood, metal, plastic, or glass, depending on the desired aesthetic appeal and functional requirements.

The present disclosure includes as contained in the appended claims, as well as that of the foregoing description. Although the invention has been described and illustrated in detail, it is to be understood that the same is by the way of illustration and example, and is not to be taken by way of limitation. The scope of the present invention is to be limited only by the terms of the appended claims.

1. A cabinet comprising:
a top panel (100);
a base panel (200);
a plurality of vertical posts (500) supporting the top panel (100) above the base panel (200), creating a storage space therebetween; and
one or more slat doors (300) vertically fitted in guide grooves (400) formed on the top panel (100) and the base panel (200);
wherein the slat doors (300) are slidable between an open position where at least a front of the storage space is exposed and a closed position where at least the front of the storage space is concealed.

2. The cabinet according to claim 1, wherein each vertical post (500) comprises an elongate cylindrical body (501) having:
a top end with a first fastening profile for attachment to the top panel (100); and
a bottom end with a second fastening profile for attachment to the base panel (200).

3. The cabinet according to claim 2, wherein the first fastening profile includes an internal threaded surface (504) engageable with a receiving member (510) fitted in a hole on the top panel (100).

4. The cabinet according to claim 3, wherein the receiving member (510) comprises:
an outer wall with a plurality of external teeth (511) for firm engagement with an inner surface of the hole on the top panel (100); and
a flange, with an external threaded surface, located within the outer wall for engagement with the internal threaded surface (504) of the first fastening profile.

5. The cabinet according to any one of claim 2, wherein the second fastening profile includes an external threaded surface (505) engageable with an internal threaded surface (522) of a leg member (520) in such a way that the base panel (200) is clamped therebetween.

6. The cabinet according to claim 5, wherein the leg member (520) comprises:
a main body; and
a flange (521) extending upwardly from the main body into a through hole (201) on the base panel (200);
whereby the flange (521) being recessed at a depth into a centre of the main body to form an edge that clamps the base panel (200) against the bottom end of the vertical post (500).

7. The cabinet according to claim 2, further comprising an intermediate panel (700) for dividing the storage space into an upper space and a lower space, whereby the intermediate panel (700) is supported horizontally between the top panel (100) and the base panel (200) by one or more first vertical posts (500) disposed within the upper space and one or more second vertical posts (500) disposed within the lower space.

8. The cabinet according to claim 7, whereby the second fastening profile of the first vertical posts (500) is engageable with the first fastening profile of the second vertical posts (500) in such a way that the intermediate panel (700) is clamped therebetween.

9. The cabinet according to any one of claim 2, wherein the elongate cylindrical body (501) includes one or more slots (502) extending along a length of the body, each slot (502) is configured to receive an edge of a partitioning panel (800) in such a way that the partitioning panel (800) can be slidably inserted between two adjacent vertical posts (500) positioned side by side on a same horizontal plane.

10. The cabinet according to any one of claim 1, wherein the vertical posts (500) are made of plastic or metal.
